(19) United States
(12) Patent Application Publication
(10) Pub. No.: US 2023/0417195 A1
(43) Pub. Date: Dec. 28, 2023

(54) THROTTLE VALVE CONTROL DEVICE

(71) Applicants: DENSO DAISHIN CORPORATION, Tokoname-shi (JP); DENSO CORPORATION, Kariya-city (JP)

(72) Inventors: Takumi NAGAYA, Tokoname-shi (JP); Tohru SHIMIZU, Tokoname-shi (JP)

(21) Appl. No.: 18/337,494

(22) Filed: Jun. 20, 2023

(30) Foreign Application Priority Data
Jun. 23, 2022 (JP) 2022-101336

(51) Int. Cl. F02D 9/10; F16K 31/04

(52) U.S. Cl. CPC F02D 9/1065; F16K 31/042

(57) ABSTRACT

A throttle valve control device includes a valve arranged in a passage of a body and rotating together with a shaft to open and close the passage. A motor rotates the shaft such that the shaft is located at a valve fully-closed position, a valve fully-open position, or a valve intermediate position which is between the valve fully-closed position and the valve fully-open position. A coil spring applies a spring force to the shaft. A rotation angle sensor detects an opening degree of the valve. A controller executes a valve intermediate-position control within a range between a fully-open side threshold and a fully-closed side threshold between which the valve intermediate position is interposed. Outside the range, the controller executes a fully-open side control and a fully-closed side control which are different from the valve intermediate-position control.

### CROSS REFERENCE TO RELATED APPLICATION

This application is based on and incorporates herein by reference Japanese Patent Application No. 2022-101336 filed on Jun. 23, 2022.

### TECHNICAL FIELD

The present disclosure relates to a throttle valve control device.

### BACKGROUND

When a throttle valve device is applied to the electronic throttle device, the throttle valve device enables an automobile to run in a limp mode in case some troubles occur in an engine control unit that controls an operating state of an engine or in the electronic throttle device. More specifically, when a motor of the electronic throttle device cannot generate a driving force, a throttle valve is controlled to stop at a valve intermediate position rather than at a position where an intake passage is fully closed.

### SUMMARY

According to at least one embodiment of the present disclosure, a throttle valve control device includes a body, a valve, a motor, a coil spring, a rotation angle sensor and a controller. The body has a passage and a motor space. The valve is arranged in the passage of the body and configured to rotate together with a shaft to open and close the passage. The motor is held in the motor space of the body and configured to rotate the shaft such that the shaft is located at a valve fully-closed position at which the valve is fully closed, a valve fully-open position at which the valve is fully open, or a valve intermediate position which is between the valve fully-closed position and the valve fully-open position. The coil spring is arranged in the body and configured to apply a spring force as an opposing force to the shaft when the shaft rotates from the valve intermediate position to the valve fully-closed position and when the shaft rotates from the valve intermediate position to the valve fully-open position. The rotation angle sensor detects an opening degree of the valve. The controller executes a valve intermediate-position control within a range between a fully-open side threshold and a fully-closed side threshold. The fully-open side threshold is set between the valve intermediate position and the valve fully-open position. The fully-closed side threshold is set between the valve intermediate position and the valve fully-closed position. The controller executes a fully-open side control within a range between the valve fully-open position and the fully-open side threshold. The controller executes a fully-closed side control within a range between the valve fully-closed position and the fully-closed side threshold. The fully-open side control and the fully-closed side control are defined as a first control. The valve intermediate-position control is defined as a second control and different from the first control.

### BRIEF DESCRIPTION OF DRAWINGS

The details of one or more embodiments are set forth in the accompanying drawings and the description below. Other features and advantages will be apparent from the description and drawings, and from the claims.

FIG. 1 is a vertical cross-sectional view of an electronic throttle device.

FIG. 2 is a front view of a body.

FIG. 3 is an exploded perspective view showing a valve gear, a coil spring, a first guide, a second guide, and a bearing.

FIG. 4 is a front view of the body in which an intermediate gear and the valve gear are omitted from FIG. 2.

FIG. 5 is a cross-sectional view taken along a line V-V in FIG. 4.

FIG. 6 is a cross-sectional view taken along a line VI-VI in FIG. 5.

FIG. 7 is a cross-sectional view taken along a line VII-VII in FIG. 5.

FIG. 8 is a perspective view showing a subassembly including the first guide, the coil spring and the second guide.

FIG. 9 is a front view showing the first guide and the second guide.

FIG. 10 is a diagram for explaining change in position of the coil spring.

FIG. 11 is a front view showing a positional relationship between the guides, a driving portion, and a holding portion.

FIG. 12 is a front view showing another positional relationship between the guides, a driving portion, and a holding portion.

FIG. 13 is a diagram illustrating a hysteresis of spring force of the coil spring.

FIG. 14 is a block diagram showing an electronic throttle control device.

FIG. 15 is a diagram for explaining hunting.

FIG. 16 is a diagram for explaining overshoot.

FIG. 17 is a diagram for explaining undershoot.

FIG. 18 is a block diagram showing control of the electronic throttle control device.

FIG. 19 is a flowchart showing a control of the electronic throttle control device.

FIG. 20 is a flowchart showing a control of the electronic throttle control device.

FIG. 21 is a diagram for explaining another example of change in position of the coil spring.

FIG. 22 is a diagram for explaining control with a small integral gain value.

FIG. 23 is a diagram for explaining control with a large integral offset amount.

FIG. 24 is a diagram for explaining a relationship between a rotation angle sensor and a magnetic circuit formed by a first magnet and a second magnet.

### DETAILED DESCRIPTION

To begin with, examples of relevant techniques will be described. A throttle valve that performs a control according to the present disclosure may be applicable, for example, in an electronic throttle device for controlling intake air of an engine, an EGR valve used in an exhaust gas circulation system, a pressure control valve in an intake passage for a diesel engine, and a negative pressure control valve for controlling a hydrogen concentration of a fuel cell.

More specifically, a throttle valve device includes a coil spring that biases and holds a valve at a position where a passage is slightly opened by the valve (hereinafter, this position is referred to as a “valve intermediate position”), rather than at a position where the passage is fully closed by the valve.

For example, when the throttle valve device is applied to the electronic throttle device, the throttle valve device enables an automobile to run in a limp mode in case some troubles occur in an engine control unit that controls an operating state of an engine or in the electronic throttle device. More specifically, when a motor of the electronic throttle device cannot generate a driving force, a throttle valve is configured to stop at the valve intermediate position rather than at a position where an intake passage is fully closed.

In an electronic throttle device according to a first comparative example, a coil spring is used, and guides are arranged at opposite ends of the coil spring. An end of the coil spring is engaged with a driving portion of a valve gear, and the valve gear rotates a valve from a valve intermediate position. Also, the end of the coil spring is engaged with a holding portion of a body so that the valve can be held at the valve intermediate position.

On the other hand, in an electronic throttle control device according to a second comparative example, an opening of a throttle valve is controlled using a motor. This control uses a proportional term, an integral term, and a derivative term.

In contras to the comparative examples, the present disclosure provides a control device for a throttle valve capable of holding a valve at a valve intermediate position by using a coil spring. Then, an opening degree of the valve can be appropriately controlled from a valve fully-closed position to a valve fully-open position through the valve intermediate position.

According a first aspect of the present disclosure, a throttle valve control device includes a body, a valve, a motor, a coil spring, a rotation angle sensor and a controller. The body has a passage and a motor space. The valve is arranged in the passage of the body and configured to rotate together with a shaft to open and close the passage. The motor is held in the motor space of the body and configured to rotate the shaft such that the shaft is located at a valve fully-closed position at which the valve is fully closed, a valve fully-open position at which the valve is fully open, or a valve intermediate position which is between the valve fully-closed position and the valve fully-open position. The coil spring is arranged in the body and configured to apply a spring force as an opposing force to the shaft when the shaft rotates from the valve intermediate position to the valve fully-closed position and when the shaft rotates from the valve intermediate position to the valve fully-open position. The rotation angle sensor detects an opening degree of the valve.

The controller executes a valve intermediate-position control within a range between a fully-open side threshold and a fully-closed side threshold. The fully-open side threshold is set between the valve intermediate position and the valve fully-open position. The fully-closed side threshold is set between the valve intermediate position and the valve fully-closed position. The controller executes a fully-open side control within a range between the valve fully-open position and the fully-open side threshold. The controller executes a fully-closed side control within a range between the valve fully-closed position and the fully-closed side threshold. The fully-open side control and the fully-closed side control are defined as a first control. The valve intermediate-position control is defined as a second control and different from the first control.

At the valve intermediate position, the spring force of the coil spring is applied to the shaft. Thus, if the valve intermediate-position control performed at the valve intermediate position is the same as the fully-open side control and the fully-closed side control performed at the other positions, hunting, overshoot, or undershoot may occur at the valve intermediate position. In the present disclosure, since the second control at the valve intermediate position is different form the first control at the other positions, occurrence of the hunting, overshoot, or undershoot can be reduced.

According to a second aspect of the present disclosure, the second control is lower in control sensitivity than the first control. Since the control sensitivity is low in the second control, the occurrence of hunting, overshoot, or undershoot can be reduced.

According to a third aspect of the present disclosure, the second control is higher in responsiveness than the first control. When the control sensitivity is low in the second control, the occurrence of hunting, overshoot, or undershoot can be reduce. On the other hand, a responsiveness may deteriorate. In the third aspect of the present disclosure, such disadvantage of the control for lowering the control sensitivity can be compensated by increasing the responsiveness.

According to a fourth aspect of the present disclosure, the control of the controller is based on the premise that a movable range of the shaft includes a dead zone (i.e., spring-force free zone) in which the shaft is free from the spring force of the coil spring at the valve intermediate position when the valve is rotated from the valve fully-open position to the valve intermediate position and when the valve is rotated from the valve fully-closed position to the valve intermediate position. The dead zone in which the spring force of the coil spring is not applied to the shaft may be generated at the valve intermediate position due to, for example, a dimensional difference generated when the body and the coil spring are combined. In this dead zone, hunting, overshoot, or undershoot is more likely to occur. The control of the present disclosure can reduce the occurrence of hunting, overshoot, or undershoot.

According to a fifth aspect of the present disclosure, the fully-open side threshold is between the valve fully-open position and the dead zone. Further, the fully-closed side threshold is between the valve fully-closed position and the dead zone. In the present disclosure, by setting the dead zone between the fully-open side threshold and the fully-closed side threshold, the occurrence of hunting, overshoot, or undershoot in the dead zone can be reliably reduced.

According to a sixth aspect of the present disclosure, the first control and the second control are controls including a proportional term and an integral term. A gain value of the integral term in the second control is smaller than a gain value of the integral term in the first control. By reducing the gain value of the integral term in the second control, the second control can be lower in the control sensitivity than the first control. As a result, the occurrence of hunting, overshoot, or undershoot can be reduced.

According to a seventh aspect of the present disclosure, the first control and the second control are controls including a proportional term and an integral term. An offset of the integral term in the second control is larger than an offset of the integral term in the first control. By increasing the offset of the integral term in the second control, the second control can be higher in responsive than the first control. In the seventh aspect of the present disclosure, such disadvantage of the control for lowering the control sensitivity can be compensated by increasing the responsiveness.

According to an eighth aspect of the present disclosure, the controller further executes a control for learning of at least one of the valve intermediate position or the valve fully-closed position. The fully-open side threshold and the fully-closed side threshold are determined based on a result of the learning. In the eighth aspect of the present disclosure, since the valve intermediate-position control can be performed based on an actual value of the valve intermediate position or an actual value of the valve fully-closed position, the second control can be reliably performed at the valve intermediate position.

According to a ninth aspect of the present disclosure, the controller obtains a difference between a target opening degree of the valve and an actual position detected by the rotation angle sensor, executes a steady control when the difference is smaller than or equal to a predetermined value, and executes a transient control when the difference is larger than the predetermined value. The controller executes the first control and the second control in the steady control. The second control as the valve intermediate-position control of the present disclosure is performed in a steady state because a high sensitivity in response to occurrence of hunting, overshoot, or undershoot is more required in the steady state than in a transient state.

An embodiment will be described below with reference to the drawings, in which a throttle valve control device of the present disclosure is applied to an electronic throttle device 1. As described above, the throttle valve control device of the present disclosure can be widely used as a throttle valve control device such as an EGR valve, a pressure control valve for an intake passage of a diesel engine, and a negative pressure control valve for a fuel cell. Therefore, terms such as a “throttle shaft” and a “throttle valve” described below are just examples in use of the present disclosure in the electronic throttle device 1, but the uses of the shaft and the valve are not limited to the throttle.

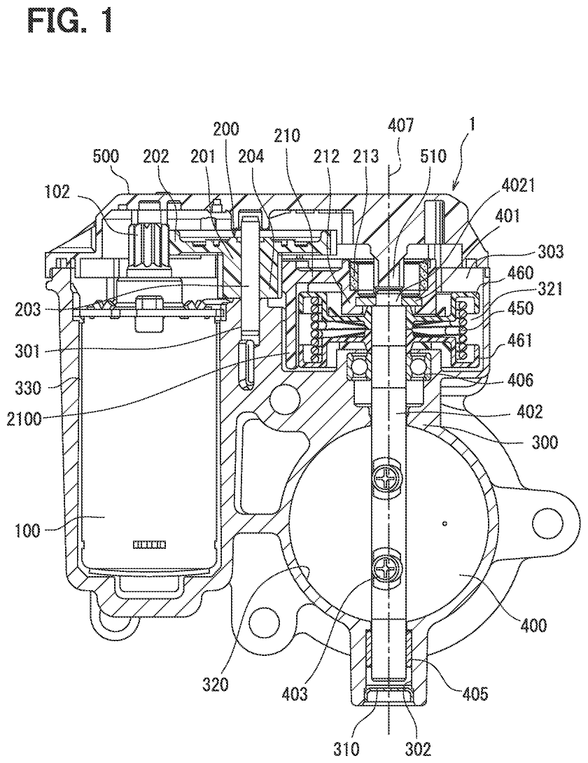

FIG. 1 is a vertical cross-sectional view of the electronic throttle device 1. An overview of the electronic throttle device 1 will be described with reference to FIG. 1. The electronic throttle device 1 is arranged in an engine compartment and controls a flow rate of an intake air taken into an engine. An engine control unit 710 (ECU 710) shown in FIG. 14 calculates an optimum intake amount in accordance with, for example, a driver's accelerator pedal operation and an engine rotation state, and outputs a rotation rate to a motor 100 according to the calculation results.

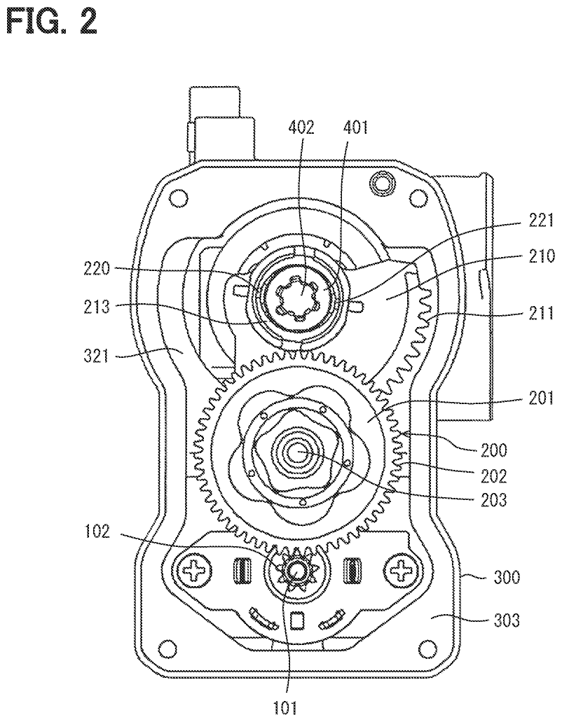

The motor 100 is arranged in a motor space 330 of a body 300 made of aluminum or an aluminum alloy. Rotation of the motor 100 is transmitted to a speed reduction mechanism 200 via a motor pinion 102 press-fitted and fixed to a motor shaft 101 (shown in FIG. 2). As shown in FIG. 2, the speed reduction mechanism 200 includes the motor pinion 102, an intermediate gear 201, and a valve gear 210.

A large-diameter gear 202 of the intermediate gear 201 meshes with the motor pinion 102. The intermediate gear 201 is held to be rotatable about an intermediate shaft 203. The intermediate shaft 203 is press-fitted and fixed into a fitting hole 301 of the body 300. A small-diameter gear 204 of the intermediate gear 201 meshes with a teeth portion 211 that is formed in an arc shape on an outer circumferential surface of the valve gear 210. Rotation of the motor pinion 102 is transmitted to the valve gear 210 via the intermediate gear 201. Therefore, rotation of the motor shaft 101 is decelerated by the intermediate gear 201 and the valve gear 210 and then transmitted to a throttle shaft 402.

A yoke 213 having a cylindrical shape is arranged on an inner circumferential surface of a cup center portion 212 of the valve gear 210. A first magnet 220 and a second magnet 221 are positioned to face the yoke 213. The first magnet 220, the second magnet 221 and the yoke 213 form a magnetic circuit. A lever 401 having a circular-plate shape is disposed in a deep portion (the lower side in FIG. 1) of the cup center portion 212 of the valve gear 210. The first magnet 220, the second magnet 221 and the lever 401 are insert-molded with the valve gear 210.

An end surface of the throttle shaft 402 has an engaging portion 4021, and the lever 401 has a surface that engages with the engaging portion 4021. The lever 401 is swaged on the end surface of throttle shaft 402 while being engaged with engaging portion 4021 of throttle shaft 402. Therefore, the valve gear 210 is connected to the throttle shaft 402 via the lever 401, and rotation of the valve gear 210 is transmitted to the throttle shaft 402. A throttle valve 400 having a circular-plate shape is fixed to the throttle shaft 402 by a screw 403. The throttle valve 400 increases or decreases an opening area of an intake passage 320 formed in the body 300 according to rotation of the throttle valve 400.

An open end 303 of the body 300 (the upper side in FIG. 1, the front side in FIG. 2) is covered by a cover 500. The cover 500 has a substantially rectangular shape corresponding to the shape of body 300. The cover 500 is formed of a resin such as polybutylene terephthalate (PBT), and ribs are provided at predetermined locations to increase its strength.

A pair of rotation angle sensors 510, which are Hall ICs, are disposed in the cover 500 at positions corresponding to an axis 407 of the throttle shaft 402. The rotation angle sensors 510 are fixed to the cover 500. The first magnet 220 and the second magnet 221 are a pair of magnets. The pair of magnets and the yoke 213 have been insert-molded with the valve gear 210 and arranged on an outer periphery of the rotation angle sensors 510. Since the first magnet 220 and the second magnet 221 rotate around the axis 407 according to the rotation of the throttle shaft 402, the magnetic circuit changes in position according to a rotation angle of the throttle valve 400 as shown in FIG. 24. The rotation angle sensors 510 detect a change in magnetic force caused by the positional change of the magnetic circuit, thereby detecting an opening degree of the throttle valve 400. Then, the detected positional information is fed back to the ECU 710.

The throttle shaft 402 is rotatably supported in the body 300 by a first bearing 405 and a second bearing 406. The first bearing 405 and the second bearing 406 are located opposite sides of the throttle valve 400 and face each other across the throttle valve 400. The first bearing 405 is a plain bearing, and the second bearing 406 is a ball bearing. An opening 302 of the body 300 is an opening through which the first bearing 405 is inserted, and the opening 302 is covered by a plug 310.

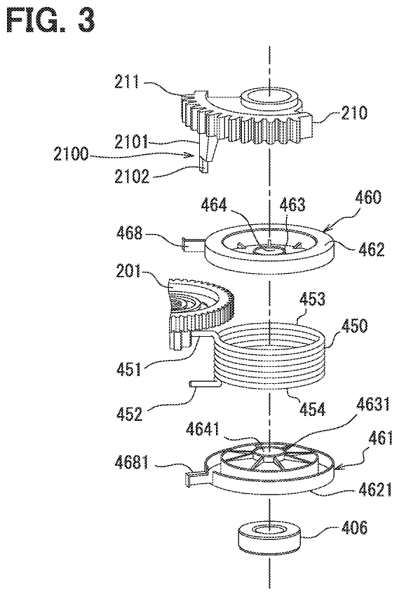

The body 300 has a space 321 for housing the valve gear 210, and a coil spring 450 for urging the throttle shaft 402 by a spring force is arranged in this space 321. The coil spring 450 is made of spring steel and has a cylindrical shape with a diameter of about 15 mm as shown in FIG. 3. The throttle shaft 402 is arranged radially inward of the coil spring 450 having a cylindrical shape. In other words, the coil spring 450 is rotatably arranged radially outward of the throttle shaft 402. One end of the coil spring 450 is a first spring end 451, and the other end of the coil spring 450 is a second spring end 452. The first spring end 451 and the second spring end 452 are bent outward in a radial direction and protrude outward by about 5 mm.

A first end surface 453 that is one end surface of the coil spring 450 is covered by a first guide 460. A second end surface 454 that is another end surface of the coil spring 450 is covered by a second guide 461. Both the first guide 460 and the second guide 461 are made of nylon 66 resin. Although the first guide 460 is described below, the description of the first guide 460 also applies to the second guide 461.

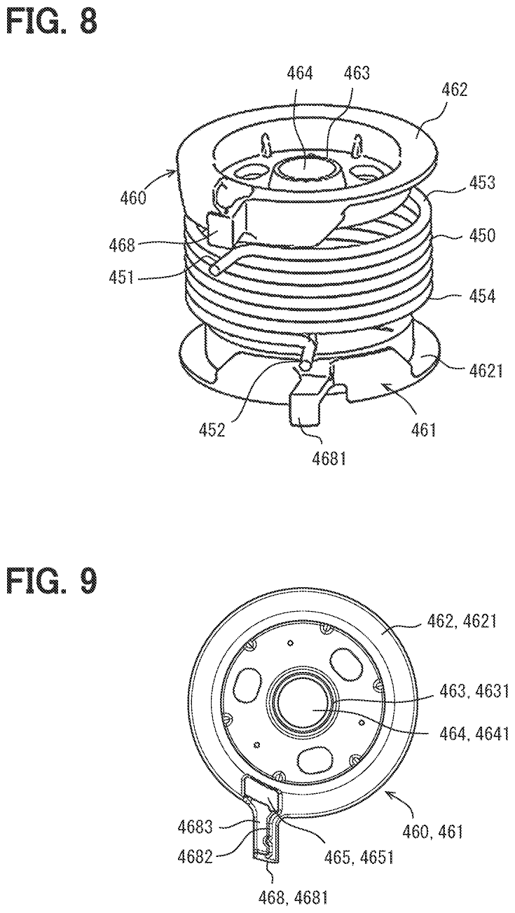

As shown in FIGS. 8 and 9, the first guide 460 includes a first annular portion 462 that covers the first end surface 453 of the cylindrical coil spring 450. Then, the first end surface 453 of the coil spring 450 is housed in the first annular portion 462. The first guide 460 has a hub 463 formed at the center of the first annular portion 462, and a first through hole 464 is formed at the center of the hub 463. The throttle shaft 402 is loosely fitted into the first through hole 464. Thus, the first guide 460 is disposed rotatably around the throttle shaft 402.

The first guide 460 has a first guide hook 468 that protrudes in the radial direction outward from the first annular portion 462. As shown in FIGS. 8 and 9, the first guide hook 468 includes a stopper surface 4682 that contacts the first spring end 451 to receive the spring force of the coil spring 450, and a protector 4683 that is provided opposite the stopper surface 4682 and covers a lateral surface of the first spring end 451. The first guide hook 468 includes a first spring hole 465 through which the first spring end 451 extends. The first spring hole 465 is open at a proximal end of the first guide hook 468 of the first annular portion 462. The first spring hole 465 improves ease of attachment of the coil spring 450, and the protector 4683 prevents the coil spring 450 from falling off. Thus, the spring force of the first spring end 451 is surely transmitted to the stopper surface 4682 by the first spring hole 465 and the protector 4683.

Although the first guide 460 has been described above, the second guide 461 has the same shape as the first guide 460 as described above. Therefore, the description regarding the first guide 460 can also be applied to the second guide 461. Therefore, reference numerals of components of the second guide 461 are also shown in FIG. 9. The second guide 461 also includes a second annular portion 4621, a hub 4631 formed at the center of the second annular portion 4621, and a second through hole 4641 that is open at the center of the hub 4631. Similarly, a second guide hook 4681 extends in a radial direction outward from an outer periphery of the second annular portion 4621. A second spring hole 4651 is open in the second annular portion 4621. Although the first guide 460 and the second guide 461 have been described with reference to FIGS. 8 and 9, the first guide 460 and the second guide 461 in FIG. 1 also have the same shape.

Since the first guide 460 and the second guide 461 have the same shape, it is not necessary to classify the first guide 460 and the second guide 461 at the time of assembling, and as a result, assembling time can be reduced. In addition, the same shape can reduce a cost of an assembling equipment and a cost of the components.

However, the second guide 461 is placed to be reversed with respect to the first guide 460. Therefore, as shown in FIG. 3, the first annular portion 462 of the first guide 460 houses and holds the first end surface 453 of the coil spring 450, while the second annular portion 4621 of the second guide 461 houses and holds the second end surface 454 of the coil spring 450.

As shown in FIG. 1, the first guide 460, the coil spring 450, and the second guide 461 are arranged around the throttle shaft 402 on a back surface (the lower side in FIG. 1) of the valve gear 210. Then, the hub 463 of the first guide 460 is brought into contact with the metal lever 401, and the hub 4631 of the second guide 461 is brought into contact with an inner race of the ball bearing (i.e., second bearing 406).

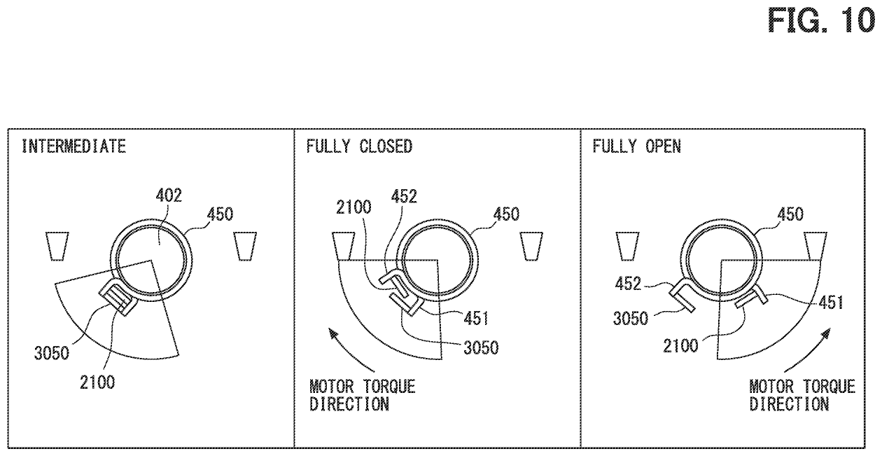

FIG. 10 briefly shows a behavior of the coil spring 450, and the body 300 has a holding portion 3050 that receives the spring force of the coil spring 450. An urging force of the coil spring 450 holds the throttle valve 400 at a valve intermediate position in the intake passage 320. Although this valve intermediate position corresponds to a closed position, the throttle valve 400 does not fully close the intake passage 320 so as to allow the vehicle to run in a limp mode in case of malfunction. That is, the intake passage 320 is slightly open so that a predetermined amount of intake air can flow therethrough. FIG. 10 shows that the first spring end 451 and the second spring end 452 of the coil spring 450 are in direct contact with the holding portion 3050 for the sake of simplification. However, in reality, the first guide hook 468 of the first guide 460 and the second guide hook 4681 of the second guide 461 are in contact with the holding portion 3050.

The spring force of the coil spring 450 is also applied to a driving portion 2100 that is integrally formed with the valve gear 210. Similar to the above, the driving portion 2100 is actually arranged between the first guide hook 468 of the first guide 460 and the second guide hook 4681 of the second guide 461. In FIG. 10, the quarter circles indicate the movement zones of the driving portion 2100. The driving portion 2100 rotates clockwise from the valve intermediate position to a valve fully-closed position, and rotates counterclockwise from the valve intermediate position to a valve fully-open position. During this rotation, the driving portion 2100 engages with either one of the first guide hook 468 of the first guide 460 or the second guide hook 4681 of the second guide 461 such that the driving portion 2100 pushes the first spring end 451 or the second spring end 452 of the coil spring 450. At this time, the other of the first guide hook 468 of the first guide 460 or the second guide hook 4681 of the second guide 461 is engaged with the holding portion 3050 such that the first spring end 451 or the second spring end 452 of the coil spring 450 is held at its position.

Although FIG. 10 shows the brief behavior of the coil spring 450, next, the opening and closing of the throttle valve 400 will be described together with the behavior of the coil spring 450. In the present disclosure, the holding portion 3050 consists of a first body hook 305 and a second body hook 307. Both the first body hook 305 and the second body hook 307 are integrally formed on an outer surface of the body 300. When the throttle valve 400 opens the intake passage 320 in order to increase a speed of the engine, the second spring end 452 of the coil spring 450 contacts the second body hook 307 and stays at its position. Then, the first spring end 451 moves according to rotation of the throttle shaft 402. In response to this movement, the coil spring 450 applies a returning force to the throttle shaft 402, the valve gear 210, and eventually the motor 100.

On the other hand, when the throttle valve 400 closes the intake passage 320 to have the engine in an idling state, the throttle shaft 402 rotates from the valve intermediate position to the valve fully-closed position. In this case, in contrast to the fully opening movement described above, the first spring end 451 of the coil spring 450 contacts the first body hook 305 and is kept at its position, and the second spring end 452 moves in accordance with the rotation of the throttle shaft 402.

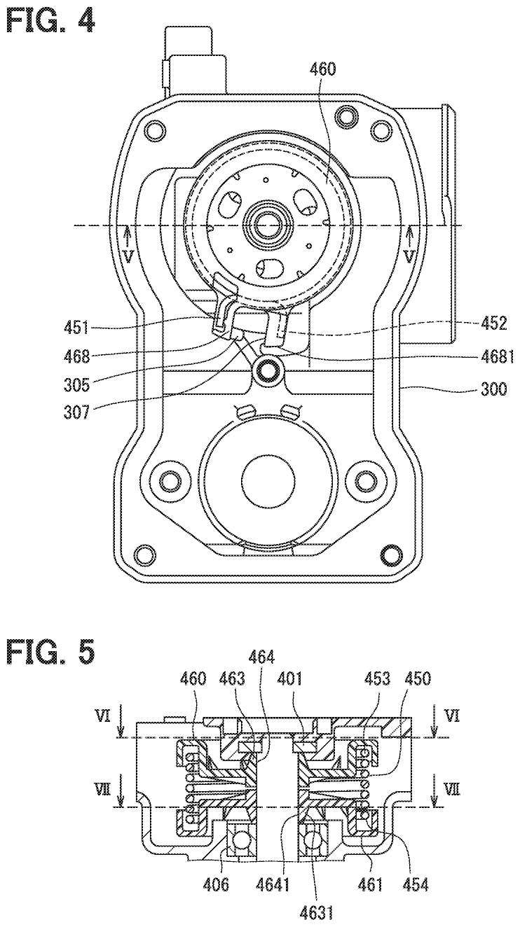

Theses movements will be described with reference to FIGS. 4 to 7. FIG. 4 is a front view in which the intermediate gear 201 and the valve gear 210 are omitted from FIG. 2, and shows the throttle valve 400 at the valve intermediate position. The first guide hook 468 of the first guide 460 is in contact with the first body hook 305 formed on the body 300. At the same time, the second guide hook 4681 of the second guide 461 is in contact with the second body hook 307 formed on the body 300. Therefore, the spring force of the coil spring 450 is not applied to the valve gear 210 at the valve intermediate position.

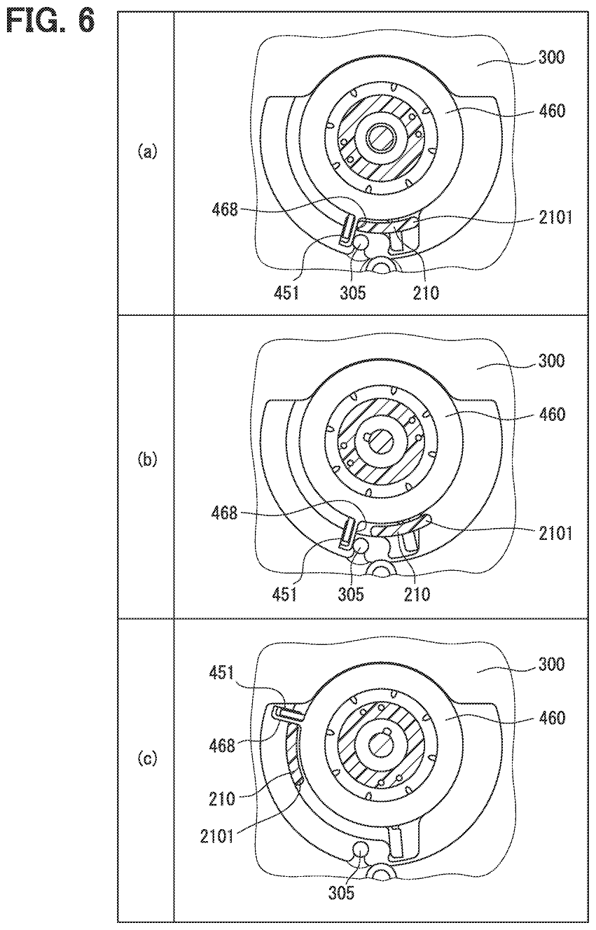

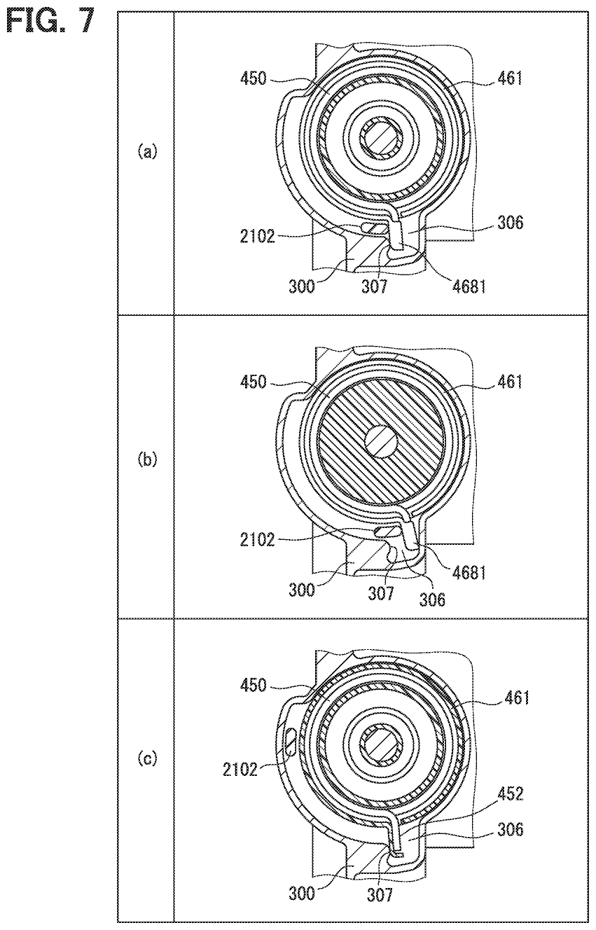

FIG. 5 is a cross-sectional view taken along the line V-V of FIG. 4, and as shown in the figure, the first guide 460 and the second guide 461 are interposed and held between the lever 401 and the second bearing 406. FIGS. 6 and 7 are cross-sectional views taken along the VI-VI line and the VII-VII line of FIG. 5, respectively. FIGS. 6(a) and 7(a) show the valve intermediate position, FIGS. 6(b) and 7(b) show the valve fully-closed position, and FIGS. 6(c) and 7(c) show the valve fully-open position. As shown in FIG. 3, the driving portion 2100 of the valve gear 210 has a first valve gear hook 2101 on an end of the driving portion 2100 facing the teeth portion 211. The first valve gear hook 2101 can be in contact with the first guide hook 468 of the first guide 460. The driving portion 2100 has a second valve gear hook 2102 on an end of the driving portion 2100 facing away from the teeth portion 211. The second valve gear hook 2102 can be in contact with the second guide hook 4681 of the second guide 461.

As shown in FIG. 6, at a valve position between the valve intermediate position (position (a)) and the fully closed position (position (b)), the first guide hook 468 holding the first spring end 451 remains in contact with the first body hook 305 of the body 300. The first valve gear hook 2101 of the valve gear 210 is simply separated from the first guide hook 468. In contrast, at a valve position between the valve intermediate position (position (a)) and the fully open position (position (c)), the first guide hook 468 is moved clockwise by the first valve gear hook 2101 of the valve gear 210.

Next, the movement of the second guide hook 4681 is shown in FIG. 7. At a valve position between the valve intermediate position (position (a)) and the fully closed position (position (b)), the second guide hook 4681 holding the second spring end 452 moves counterclockwise in a movement groove 306 of the body 300 according to a rotation of the second valve gear hook 2102 of the valve gear 210. In contrast, at a valve position between the valve intermediate position (position (a)) and the fully open position (position (c)), the second guide hook 4681 does not move and remains in contact with the second body hook 307 which is one end of the movement groove 306 of the body 300.

As described above, at the valve intermediate position, it is premised that the first guide hook 468 and the second guide hook 4681 are both in contact with the holding portion 3050 and the driving portion 2100. Based on this premise, the rotation of the valve gear 210 from the valve intermediate position due to the rotation of the motor 100 can cause the throttle valve 400 to open and close the intake passage 320 without delay.

However, the first valve gear hook 2101 and the second valve gear hook 2102 are provided at different portions of the driving portion 2100. Therefore, the position of the holding portion 3050 and the position of the driving portion 2100 may deviate due to errors in processing or assembly or component tolerances. If these position deviations occur, a non-contact portion may be generated between the first guide hook 468 and the first body hook 305, between the first guide hook 468 and the first valve gear hook 2101, between the second guide hook 4681 and the second body hook 307, or between the second guide hook 4681 and the second valve gear hook 2102.

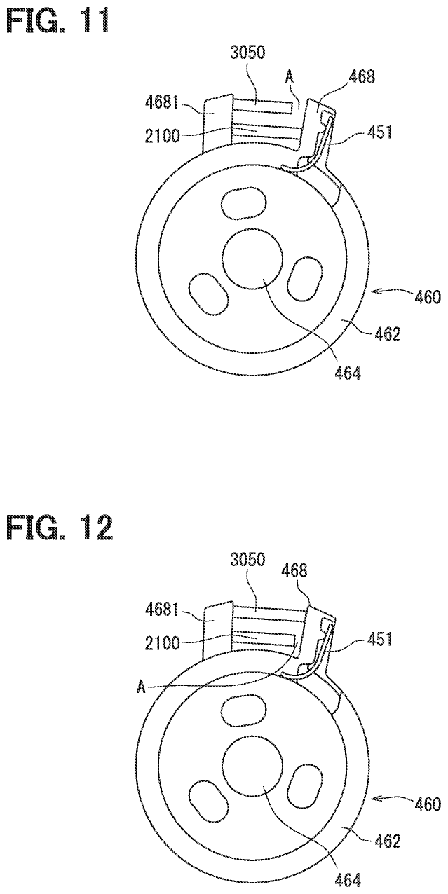

For example, as shown in FIG. 11, it is assumed that a base end of the first guide hook 468 is in contact with the driving portion 2100, but a tip end of the first guide hook 468 is not in contact with the holding portion 3050. Then, a gap A is generated in this non-contact portion where the tip end of the first guide hook 468 is not in contact with the holding portion 3050. The size of this gap A may be about 0.2 mm due to accumulation of tolerances, and may become larger if a processing error is added to this. Since the spring force of the coil spring 450 does not work in a zone of this gap A, the position of the throttle valve 400 is not stable.

The same applies to a case where, as shown in FIG. 12, the base end of the first guide hook 468 is not in contact with the driving portion 2100, but the tip end of the first guide hook 468 is in contact with the holding portion 3050. Also in this case, the spring force of the coil spring 450 does not act in the zone of the gap A of the non-contact portion. Therefore, the zone of the gap A becomes a dead zone (i.e., spring-force free zone) in which the shaft 402 is free from the spring force of the coil spring 450.

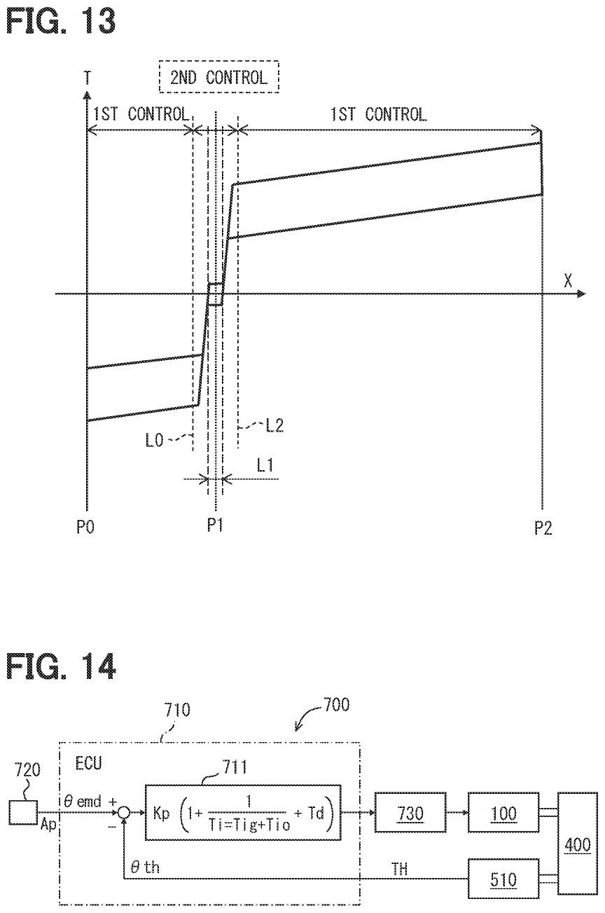

If the non-contact portion is generated, the spring force of the coil spring 450 will not be generated although the motor 100 is rotated to rotate the valve gear 210. As shown in FIG. 13, since the valve intermediate position P1 is not fixed, the position of the throttle valve 400 is not stable. Therefore, an amount of intake air flowing from the throttle valve 400 also varies, and there is a concern that running of the vehicle in the limp mode may be hindered. The horizontal axis of FIG. 13 indicates an opening degree X of the throttle valve 400. The vertical axis indicates a shaft torque T of the throttle shaft 402, and represents a magnitude of the spring force of the coil spring 450.

The upper direction of the vertical axis indicates a torque of movement in the clockwise direction of FIG. 6, and the lower direction indicates a torque of movement in the counterclockwise direction of FIG. 7. The farther away from the center, the greater the torque. The movement in the clockwise direction in FIG. 6 from the valve intermediate position P1 toward the valve fully-open position P2 is against the spring force of the coil spring 450 and thus requires a large torque. In contrast, the movement from the valve fully-open position P2 to the valve intermediate position P1 is accelerated by the spring force of the coil spring 450 but requires a predetermined torque for keeping its position. The torque required in the movement from the valve fully-open position P2 to the valve intermediate position P1 is smaller than the torque required in the movement from the valve intermediate position P1 to the valve fully-open position P2. Therefore, a torque required to be output by the motor 100 has hysteresis. This hysteresis occurs also in movement between the valve intermediate position P1 and the valve fully-closed position P0.

The dead zone L1 free from the spring force of the coil spring 450 is caused, as described above, by the fact that the valve intermediate position P1 is not determined. In addition, the torque required for the motor 100 does not become 0 even at the valve intermediate position P1, and discontinuously changes in the dead zone L1. That is, hysteresis occurs in the torque of the motor 100 also in the dead zone L1. This hysteresis is different from the hysteresis in the movement between the valve intermediate position P1 and the valve fully-open position P2 or the hysteresis in the movement between the valve intermediate position P1 and the valve fully-closed position P0. This is because the hysteresis in the movement between the valve intermediate position P1 and the valve fully-open position P2 and the hysteresis in the movement between the valve intermediate position P1 and the valve fully-closed position P0 are caused by the spring force of the coil spring 450, and the magnitudes of them can be calculated in advance. On the other hand, presence or absence of the hysteresis and an influence of the hysteresis in the dead zone L1 are difficult to be predicted.

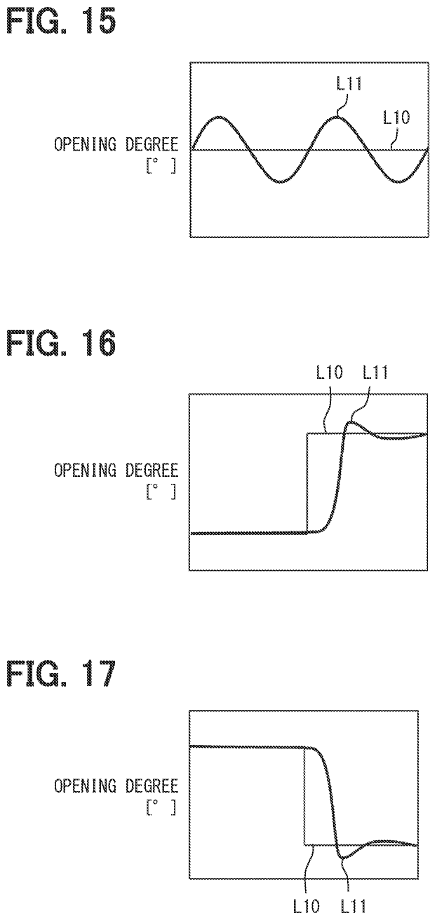

As a result, if the control performed in the movement between the valve intermediate position P1 and the valve fully-open position P2 or the movement between the valve intermediate position P1 and the valve fully-closed position P0 is the same as a control performed in the dead zone L1, as illustrated in FIG. 15, hunting may occur, in other words, the position of the throttle valve 400 may not be constant. In FIG. 15, a target angle of the throttle valve 400 is indicated by L10, and an actual angle is indicated by L11. Similarly, there may be an overshoot (illustrated in FIG. 16) in which the actual angle L11 of the throttle valve 400 becomes equal to or greater than the target angle L10 or, conversely, an undershoot (illustrated in FIG. 17) in which the actual angle L11 of the throttle valve 400 becomes equal to or less than the target angle L10.

Therefore, a controller 700 of the present disclosure executes a valve intermediate-position control in a zone including the valve intermediate position P1, and the valve intermediate-position control is different from a fully-open side control and a fully-closed side control executed in other zones. Hereinafter, the controller 700 will be described. The controller 700 includes the ECU 710 as shown in FIG. 14. A request signal for engine output received from an accelerator pedal sensor 720 is input to the ECU 710. The ECU 710 calculates an intake air amount together with a fuel injection amount, ignition timing, and the like based on the request signal. The calculation of the ECU 710 is performed using a proportional term, an integral term, and a derivative term. An integral constant Ti is used in the integral term, and the integral constant Ti includes an integral gain constant Tig and an integral offset constant Tio.

A drive amount is output to a motor drive circuit 730 in accordance with the calculated intake air amount. The motor drive circuit 730 rotates the motor 100 according to the output to rotate the throttle valve 400 to a predetermined position. In addition to this rotation, the motor drive circuit 730 applies a torque to the motor 100 necessary for holding the throttle valve 400 at a predetermined position. The torque by which the motor 100 holds the throttle valve 400 at the predetermined position is controlled by a duty cycle control.

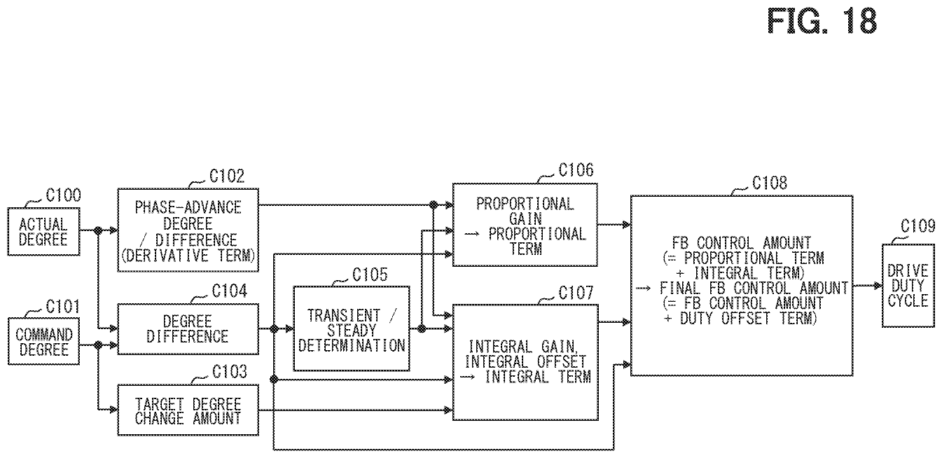

The actual opening degree of the throttle valve 400 is detected by the rotation angle sensor 510 and is input to the ECU 710 as a feedback signal. An arithmetic circuit 711 of the ECU 710 calculates the opening degree of the throttle valve 400 based on the feedback signal inputted from the rotation angle sensor 510 and the request signal inputted from the accelerator pedal sensor 720. The content of this calculation will be described with reference to FIG. 18. An actual opening degree C100 of the throttle valve 400 is determined by a signal from the rotation angle sensor 510, and a command opening degree C101 of the throttle valve 400 is determined by a signal from the accelerator pedal sensor 720. A phase-advance opening degree C. 102 is calculated by differentiating the actual opening degree C100. Additionally, the derivative term that is a difference between the differentiated actual opening degree and a differentiated command opening degree may be calculated. Also, a target opening change amount C103 is calculated from a change in the command opening degree C101.

An opening degree difference C104 is calculated from a difference between the actual opening degree C100 of the throttle valve 400 and the command opening degree C101. The opening degree difference C104 is a deviation of the actual opening degree from the target opening degree. In a transient/steady determination C105, a present state is determined to be a transient state when the deviation is large, and determined to be a steady state when the deviation is small. For example, 0.5 degrees in opening degree of the throttle valve 400 may be used for the determination whether the deviation amount is large or small. That is, if the deviation of the actual opening degree from the target is greater than 0.5 degrees, it is determined that the present state is the transient state.

When the present state is determined to be the transient state, a transient control C106 is performed. The transient control C106 performs a control including the proportional term and the integral term using the phase-advance opening degree C102, the target opening change amount C103, and the opening degree difference C104. In this transient control, a gain value of the proportional term and a gain value of the integral term are used as transient gain values. These transient gain values are extracted from a transient map corresponding to the opening degree difference C104. In the transient control C106, a proportional gain may be calculated, and the proportional term may be calculated.

When the present state is determined to be the steady state, a steady control C107 is performed. The steady control C107 also performs a control including the proportional term and the integral term using the phase-advance opening degree C102, the target opening change amount C103, and the opening degree difference C104. However, in this steady control, a gain value of the proportional term and a gain value of the integral term are used as steady gain values. The steady gain values are extracted from a steady map. In the steady control C107, an integral gain and an integral offset may be calculated, and the integral term may be calculated. The opening degree of the throttle valve 400 needs to be changed more quickly during the transient state than the steady state. In other words, since it is not necessary in the steady state to change the opening degree of the throttle valve 400 as rapidly as in the transient state, the gain values of the steady map are smaller than the gain values of the transient map. When the gain values are increased in the control of the proportional term or the integral term, a sensitivity of the control can be increased. On the other hand, when the gain values are reduced, the sensitivity of the control can be reduced.

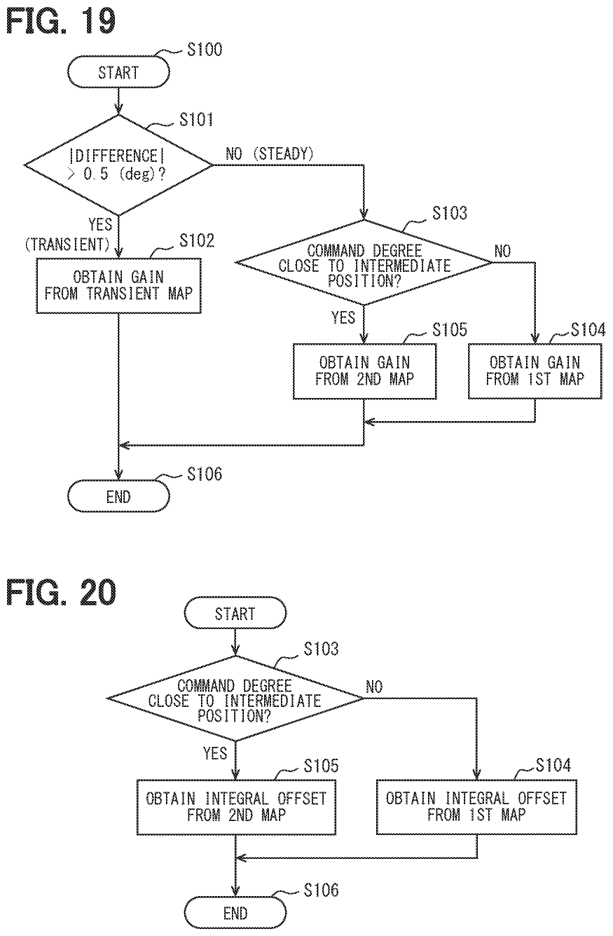

In the steady control C107, furthermore, the content of the control is changed depending on whether the opening degree of the throttle valve 400 is close to the valve intermediate position. The contents of the steady control C107 will be described with reference to FIGS. 19 and 20. In FIG. 19, after a start S100, a transient/steady determination S101 is performed to determine whether the opening degree difference C104 is larger than a predetermined value, for example, 0.5 degrees. This step of the transient/steady determination S101 is the same as the calculation of the transient/steady determination C105 described above. When the present state is determined to be the transient state (YES), a transient control S102 is performed. This step of the transient control S102 is the same as the calculation of the transient control C106 described above. The gain values are read from the transient map in accordance with the opening degree difference C104 in the transient state, and the proportional term and the integral term are controlled in accordance with the transient state. As described above, a control with a high control sensitivity is performed in the transient state.

When the present state is determined to be the steady state (NO) in the step of the transient/steady determination S101, the valve intermediate-position determination S103 is performed to determine whether the command opening degree C101 is close to the valve intermediate position P1. More specifically, a learning control is executed. In the learning control, the valve fully-closed position P0 is learned, an angle of the valve intermediate position P1 from the valve fully-closed position P0 is calculated, and the valve intermediate position P1 is also learned. Then, the dead zone L1 shown in FIG. 13 is also determined via the learning control. In the learning control, the fully closed position P0 is stored when the engine is stopped. When a present valve fully-closed position P0 stored when the engine is stopped at the present time is different from a last valve fully-closed position P0 stored when the engine was stopped last time, the last valve fully-closed position P0 is overwritten with the present valve fully-closed position P0.

A fully-open side threshold L2 is set at a position deviated by a predetermined angle from the dead zone L1 toward the valve fully-open position P2. A fully-closed side threshold L0 is set at a position deviated by a predetermined angle from the dead zone L1 toward the valve fully-closed position P0. The fully-open side threshold is between the valve fully-open position and the dead zone, and the fully-closed side threshold is between the valve fully-closed position and the dead zone. The fully-open side threshold and the fully-closed side threshold are determined based on the result of the learning control. The predetermined angle for determining the fully-closed side threshold L0 and the fully-open side threshold L2 is, for example, about two degrees. The predetermined angle may be two degrees. The valve intermediate-position determination S103 is determination whether the command opening degree C101 is between the fully-closed side threshold L0 and the fully-open side threshold L2.

When it is determined in the valve intermediate-position determination S103 that the command opening degree is not close to the valve intermediate position P1 (NO), a first control S104 is performed as a normal steady control. In other words, the first control S104 includes the fully-open side control performed between the valve fully-open position P2 and the fully-open side threshold L2, and the fully-closed side control between the valve fully-closed position P0 and the fully-closed side threshold L0. In this first control S104, the proportional term and the integral term are controlled using the gain values obtained from the steady map (first map) described above. As described above, the gain values of the steady map (first map) is smaller than the gain values of the transient map. Therefore, a control of the opening degree of the throttle valve 400 corresponding to the steady state can be achieved.

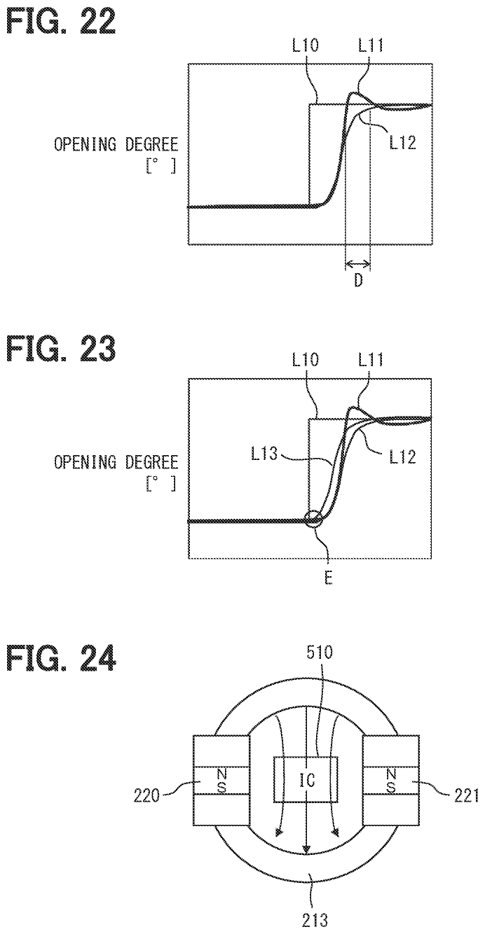

When it is determined in the valve intermediate-position determination S103 that the command opening degree is close to the valve intermediate position P1 (YES), a second control S105 is performed as a steady control at the valve intermediate position. That is, the second control is the valve intermediate-position control of the steady control. The gain values of the steady map (first map) used in the first control is smaller than the gain values of the transient map. However, since the first control is performed between the valve fully-open position P2 and the fully-open side threshold L2 and between the valve fully-closed position P0 and the fully-closed side threshold L0, the influence of the spring force of the coil spring 450 is constant. Therefore, the gain values also have a certain magnitude. If the proportional term and the integral term are controlled by using the gain values of that magnitude, hunting, overshoot, and undershoot may occur at the valve intermediate position P1. Therefore, the second control S105 uses a second map in which the gain value of the proportional term and the gain value of the integral term are smaller than those used in the first control S104. Since the gain values are small, a control with a low control sensitivity can be performed. Therefore, the hunting, overshoot, and undershoot can be reduced as indicated by a gain value control L12 in FIG. 22.

On the other hand, when the gain values are small, the control sensitivity is reduced, which leads to deterioration in response sensitivity D (illustrated in FIG. 22). Therefore, as shown in FIG. 20, an offset of the integral term is changed depending on whether the command opening degree C101 is close to the valve intermediate position P1. When it is determined in the valve intermediate-position determination S103 that the command opening degree is not close to the valve intermediate position P1 (NO), the first control S104 which is the normal steady control is performed in the same manner as the control shown in FIG. 19. When it is determined in the valve intermediate-position determination S103 that the command opening degree is close to the valve intermediate position P1 (YES), the second control S105 which is the steady control at the valve intermediate position is performed in the same manner as the control shown in FIG. 19.

However, in the first control 104 of FIG. 19, the gain values of the proportional term and the integral term are selected from the first map. In the second control 105 of FIG. 19, the gain values are selected from the second map. On the other hand, in the first control 104 in FIG. 20, the offset of the integral term is selected from a first offset map. In the second control 105 of FIG. 20, the offset of the integral term is selected from a second offset map. The offset of the integral term is related to a control responsiveness. As the offset increases, time required for rotation of the throttle valve 400 can be reduced. That is, as indicated by an offset control L13 in FIG. 23, increase of the offset accelerates a start E of the control and improves the responsiveness. Therefore, the offset of the second offset map is larger than the offset of the first offset map in the present example. As a result, the responsiveness deteriorated by reduction of the response sensitivity D due to reduction of the gain values can be compensated for by the increase of the offset in the second control S105.

In the controls of FIGS. 19 and 20, the first control 104 or the second control 105 is performed as the steady control, and then the control routine ends (S106). Referring back to FIG. 18, a PID control C108 (i.e., proportional integral derivative control) is performed by using the gain values in the transient control C106, the gain values and the offset in the steady control C107, and the opening degree difference C104. In the PID control C108, a FB control amount that is a sum of the proportional term and the integral term may be calculated. Further, a final FB control amount that is a sum of the FB control amount and the duty-cycle offset term may be calculated. Based on a calculation result of this PID control C108, a rotational speed of the motor 100 and a drive duty cycle C109 for controlling the motor 100 to maintain the opening degree of the throttle valve 400 are calculated. Based on the calculated drive duty cycle C109, the motor drive circuit 730 drives the motor 100 as described above.

In the above-described example, the gain values of the controls of the proportional term or the integral term are read from the maps. However, the gain values may be calculated based on the opening degree difference C104 or the actual opening degree C100 of the throttle valve 400, for example. Further, the gain values may be determined in advance by either the transient control C106 or the steady control C107. In the steady control C107, the gain values may be determined by either the first control S104 or the second control S105.

In addition, it is not always necessary to use the PID control as the control, and it is also possible to perform the control using only the integral term or the proportional term. Furthermore, it is also possible to use other controls such as sliding control. As a feature of the present disclosure, in the steady control C107, a difference between the second control executed in an intermediate range including the valve intermediate position P1 and the first control executed in ranges other than the intermediate range is important. Therefore, the change in the gain values or the change in the offset depending on the controls is an example providing the difference between the first control and the second control. Qualitatively, a control that can reduce hunting, overshoot, and undershoot at the time of crossing the dead zone L1 may be set as the second control.

The second control is lower in control sensitivity than the first control. Therefore, the gain value of the integral term may be reduced in the second control. However, as described above, the integral control itself is not essential, and any control that can reduce the control sensitivity may be used as the second control. Similarly, the second control is higher in the responsiveness than the first control. Therefore, the offset of the integral term may be increased such that the response sensitivity D is increased. However, since the integral control itself is not essential, another control may be executed as long as the response sensitivity D can be increased.

Further, in the example described above, the valve fully-closed position P0 is learned in the learning control. The position of the valve fully-closed position P0 is definite and appropriate for a target of the learning control. However, a position for the learning control is not limited to the valve fully-closed position P0. The valve intermediate position P1 can also be the target of the learning control as a position at which the driving portion 2100 of the valve gear 210 contacts the holding portion 3050 of the body 300 when the engine is stopped. The learning control may be appropriate for determining the position of the throttle shaft 402, but is not essential. A signal from the rotation angle sensor 510 may be used to detect the valve fully-closed position P0, the valve intermediate position P1, and the valve fully-open position P2.

Further, in the above example, the transient/steady determination S101 is used as a branch into different controls which are a control in the transient state (i.e., transient control S102) and a control in the steady state (i.e., valve intermediate-position determination S103). Then, the second control 105 of the present disclosure is executed as the control in the steady state (i.e., valve intermediate-position determination S103). It is reasonable to execute the second control S105 in the valve intermediate-position control of the present disclosure as the control in the steady state (i.e., valve intermediate-position determination S103) because a high sensitivity of response to occurrence of hunting, overshoot, or undershoot is more required in the steady state than in the transient state.

However, the present disclosure does not exclude the execution of the second control S105 in the control in the transient state (i.e., transient control S102). In addition, since the present disclosure is characterized in that the second control S105 is executed as the control in the steady state (i.e., the valve intermediate-position determination S103), the present disclosure is also applicable to a controller that does not perform the transient control S102.

Further, the control of the present disclosure is based on the premise that the dead zone L1 is present at the valve intermediate position P1, but the presence of the dead zone L1 is not essential. There is also a case where the dead zone L1 happens to be absent due to stacking of tolerances or the like. In addition, the dead zone L1 may accidentally disappear due to aging. Therefore, the valve intermediate position P1 may be within a region where the dead zone L1 may occur, and it is not necessary that the dead zone L1 is actually present.

In the example of FIG. 9, a surrounding wall was formed on the entire circumference of the first annular portion 462 of the first guide 460, but the shapes of the first guide 460 and the second guide 461 are not limited to the shapes of FIG. 9. For example, a surrounding wall may be formed only in the vicinity of the first guide hook 468 of the first annular portion 462. Accordingly, the area of the surrounding wall can be reduced and its weight can be reduced. Moreover, since the surrounding wall holds the coil spring 450 in the vicinity of the first guide hook 468, the holding of the coil spring 450 can be secured. Also, the first guide hook 468 and the second guide hook 4681 can be omitted.

Further, in this embodiment, the second spring end 452 of the coil spring 450 close to the second guide 461 moves during the rotation from the valve intermediate position to the fully closed position. The first spring end 451 close to the first guide 460 moves during the rotation from the valve intermediate position to the fully open position. However, this movements of the coil spring 450 may be reversed. Although the rotation direction of the motor 100 is also reversed, the operation is the same as this embodiment. In the present disclosure, the position of the first guide hook 468 is not specified by whether it is located close to the valve fully-open position or the valve fully-closed position.

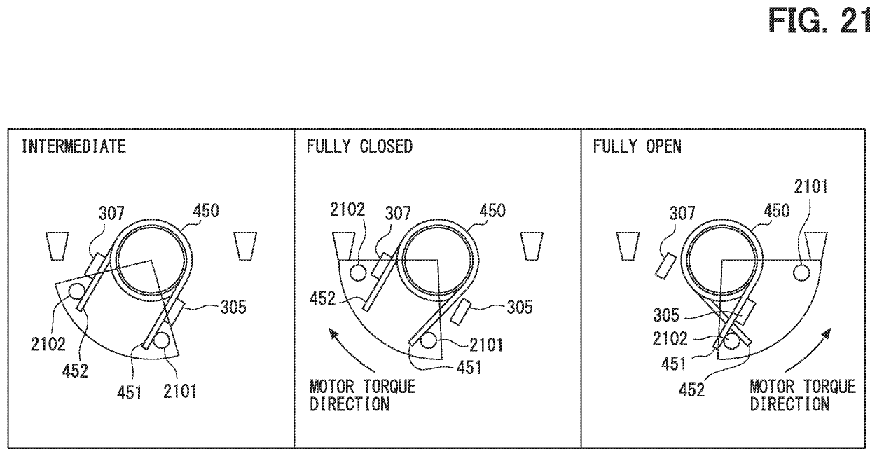

Further, in the above example, the driving portion 2100 of the valve gear 210 is arranged between the first spring end 451 and the second spring end 452, and the driving portion 2100 is sandwiched and held between and by the first spring end 451 and the second spring end 452. Alternatively, as shown in FIG. 21, the driving portion 2100 of the valve gear 210 may be arranged outside the first spring end 451 and the second spring end 452. In other words, the first spring end 451 and the second spring end 452 of the coil spring 450 may be sandwiched and held between and by the first valve gear hook 2101 and the second valve gear hook 2102. In this case, the holding portion 3050 of the body 300 is also arranged outside the first spring end 451 and the second spring end 452. Therefore, the first spring end 451 and the second spring end 452 of the coil spring 450 are sandwiched and held by the first body hook 305 and the second body hook 307.

Further, in the above example, the first guide 460 and the second guide 461 have the same shape, so that the assembly time can be shortened, the assembly equipment cost can be reduced, and the component cost can be reduced. However, if it is necessary to make the shapes of the first guide 460 and the second guide 461 different in relation to the shapes of the valve gear 210 and the body 300, the shape change must be allowed. Even if the first guide hook 468 or the second guide hook 4681 cannot be formed on either one of the guides, the shape change must be allowed.

Further, the above-described materials and dimensions of the components are also examples, and may be appropriately selected according to the requirements for the electronic throttle device 1.

As described above, the throttle valve control device according to the present disclosure may be applicable in controls of, for example, an electronic throttle device 1 for controlling an amount of intake air of an engine, an EGR valve controlling a circulation amount of exhaust gas, a intake-passage pressure control valve controlling an intake air of a diesel engine, and a negative pressure control valve controlling a hydrogen concentration of a fuel cell.

The controllers and methods described in this application may be fully implemented by a special purpose computer created by configuring a processor programmed to execute one or more particular functions embodied in computer programs. Alternatively, the apparatuses and methods described in this application may be fully implemented by special purpose hardware logic circuits. Further alternatively, the apparatuses and methods described in this application may be implemented by a special purpose computer created by a combination of a processor executing computer programs coupled with hardware logic circuits.

While the present disclosure has been described with reference to embodiments thereof, it is to be understood that the disclosure is not limited to the embodiments and constructions. To the contrary, the present disclosure is intended to cover various modification and equivalent arrangements. In addition, while the various elements are shown in various combinations and configurations, which are exemplary, other combinations and configurations, including more, less or only a single element, are also within the spirit and scope of the present disclosure.

What is claimed is:

1. A throttle valve control device comprising:
a body having a passage and a motor space;
a valve arranged in the passage of the body and configured to rotate together with a shaft to open and close the passage;
a motor held in the motor space of the body and configured to rotate the shaft such that the shaft is located at a valve fully-closed position at which the valve is fully closed, a valve fully-open position at which the valve is fully open, or a valve intermediate position which is between the valve fully-closed position and the valve fully-open position;
a coil spring arranged in the body and configured to apply a spring force as an opposing force to the shaft when the shaft rotates from the valve intermediate position to the valve fully-closed position and when the shaft rotates from the valve intermediate position to the valve fully-open position;
a rotation angle sensor configured to detect an opening degree of the valve; and
a controller configured to
execute a valve intermediate-position control within a range between a fully-open side threshold and a fully-closed side threshold, the fully-open side threshold being set between the valve intermediate position and the valve fully-open position, the fully-closed side threshold being set between the valve intermediate position and the valve fully-closed position,
execute a fully-open side control within a range between the valve fully-open position and the fully-open side threshold, and
execute a fully-closed side control within a range between the valve fully-closed position and the fully-closed side threshold, wherein
the fully-open side control and the fully-closed side control are defined as a first control, and
the valve intermediate-position control is defined as a second control and different from the first control.

2. The throttle valve control device according to claim 1, wherein
the second control is lower in control sensitivity than the first control.

3. The throttle valve control device according to claim 2, wherein
the second control is higher in responsiveness than the first control.

4. The throttle valve control device according to claim 1, wherein
a movable range of the shaft includes a dead zone in which the shaft is free from the spring force of the coil spring at the valve intermediate position when the valve is rotated from the valve fully-open position to the valve intermediate position and when the valve is rotated from the valve fully-closed position to the valve intermediate position.

5. The throttle valve control device according to claim 4, wherein
the fully-open side threshold is between the valve fully-open position and the dead zone, and
the fully-closed side threshold is between the valve fully-closed position and the dead zone.

6. The throttle valve control device according to claim 1, wherein
the first control and the second control are controls including a proportional term and an integral term, and
a gain value of the integral term in the second control is smaller than a gain value of the integral term in the first control.

7. The throttle valve control device according to claim 6, wherein
an offset of the integral term in the second control is larger than an offset of the integral term in the first control.

8. The throttle valve control device according to claim 1, wherein
the controller is further configured to execute a control for learning of at least one of the valve intermediate position or the valve fully-closed position, and
the fully-open side threshold and the fully-closed side threshold are determined based on a result of the learning.

9. The throttle valve control device according to claim 1, wherein
the controller is further configured to
obtain a difference between a target opening degree of the valve and an actual position detected by the rotation angle sensor,
execute a steady control when the difference is smaller than or equal to a predetermined value,
execute a transient control when the difference is larger than the predetermined value, and
execute the first control and the second control in the steady control.
